(19) United States
(12) Patent Application Publication
(10) Pub. No.: US 2013/0163019 A1
(43) Pub. Date: Jun. 27, 2013

(54) IMAGE PROCESSOR, IMAGE PROCESSING METHOD, AND RECORDING MEDIUM

(71) Applicants: Mikane TAGO, Kanagawa (JP); Asaki Umezawa, Tokyo (JP); Hiroshi Yamaguchi, Kanagawa (JP)

(72) Inventors: Mikane TAGO, Kanagawa (JP); Asaki Umezawa, Tokyo (JP); Hiroshi Yamaguchi, Kanagawa (JP)

(73) Assignee: RICOH COMPANY, LTD.

(21) Appl. No.: 13/685,873

(22) Filed: Nov. 27, 2012

(30) Foreign Application Priority Data
Dec. 22, 2011 (JP) 2011-281572

(51) Int. Cl. H04N 1/00

(52) U.S. Cl. CPC H04N 1/00442
USPC 358/1.13

(57) ABSTRACT

An image processor includes a display control part configured to display and control a screen that includes multiple UI components for calling preset copy functions, and a preview image; a reading control part configured to control reading of an original material, and to generate an electronic image of the original material; an image generating part configured to generate a preview image based on one or more of the copy functions called by one of the UI components at a predetermined position inside the screen, using a preset predetermined image before the original material is read or using the electronic image after the original material is read; and a screen generating part configured to generate the screen using the preview image generated by the image generating part, and to output the generated screen to the display control part.

### CROSS-REFERENCE TO RELATED APPLICATION

The present application is based upon and claims the benefit of priority of the prior Japanese Patent Application No. 2011-281572, filed on Dec. 22, 2011, the entire contents of which are incorporated herein by reference.

### BACKGROUND OF THE INVENTION

1. Field of the Invention

The present invention relates to image processing that displays a preview image.

2. Description of the Related Art

Recently, multifunction machines have become more multifunctional to include multiple applications for, for example, a copier, a scanner, a facsimile (FAX) machine, and a printer. For example, with respect to a copy function, there are multiple settings that include settings on documents, such as a document type and document orientation, settings on image processing, such as a magnification ratio, a reduction ratio, simplex/duplex (one-sided/two-sided), and a margin size, and settings on finishing, such as stamping and stapling.

In the case of using the copy function, a user properly sets up a desired function among multiple settings and presses a PRINT button in order to obtain a desired output. At this point, if the user-desired function is not properly set up, image printing ends in failure, thus wasting resources.

Accordingly, users may wish to check output under current settings before execution of printing. Therefore, a technique is known that generates a preview image from the electronic image of a read document and displays the preview image on a user interface (UI) before photocopying. For example, Japanese Laid-Open Patent Application No. 2011-124841 discloses the technique of displaying a preview image that facilitates determination of a defective finish.

### SUMMARY OF THE INVENTION

According to an aspect of the present invention, an image processor includes a display control part configured to display and control a screen that includes a plurality of UI components for calling preset copy functions, and a preview image; a reading control part configured to control reading of an original material, and to generate an electronic image of the original material; an image generating part configured to generate a preview image based on one or more of the copy functions called by one of the UI components at a predetermined position inside the screen, using a preset predetermined image before the original material is read or using the electronic image after the original material is read; and a screen generating part configured to generate the screen using the preview image generated by the image generating part, and to output the generated screen to the display control part.

According to an aspect of the present invention, a non-transitory computer-readable recording medium having a program recorded thereon for causing a computer to execute: displaying and controlling a screen that includes a plurality of UI components for calling preset copy functions, and a preview image; controlling reading of an original material, and generating an electronic image of the original material; generating a preview image based on one or more of the copy functions called by one of the UI components at a predetermined position inside the screen, using the electronic image after the original material is read; and generating the screen using the generated preview image.

According to an aspect of the present invention, an image processing method includes displaying and controlling a screen that includes a plurality of UI components for calling preset copy functions, and a preview image; controlling reading of an original material, and generating an electronic image of the original material; generating a preview image based on one or more of the copy functions called by one of the UI components at a predetermined position inside the screen, using the electronic image after the original material is read; and generating the screen using the generated preview image.

The object and advantages of the embodiments will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram illustrating a hardware configuration of an image processor according to an embodiment;

FIG. 2 is a block diagram illustrating a functional configuration of the image processor according to an embodiment;

FIG. 3 is a block diagram illustrating functions of a display control part according to an embodiment;

FIG. 4 is a diagram illustrating screen information of a copy screen according to an embodiment;

FIG. 5 is a diagram illustrating icon image information according to an embodiment;

FIG. 6 is a diagram illustrating preset copy function information according to an embodiment;

FIG. 7 is a diagram illustrating custom information according to an embodiment;

FIG. 8 is a diagram for giving an outline of a change of the copy screen according to an embodiment;

FIG. 9 is a diagram illustrating a copy screen related to basic operations from the copy screen according to an embodiment;

FIG. 10 is a diagram illustrating a screen change between portrait settings and landscape settings according to an embodiment;

FIG. 11 is a diagram illustrating a screen change in a table operation according to an embodiment;

FIG. 12 is a diagram illustrating a screen change in a preview image page checking operation according to an embodiment;

FIG. 13 is a diagram illustrating a screen change in a preview image page checking operation according to an embodiment;

FIG. 14 is a diagram illustrating a screen change in a preview image page checking operation according to an embodiment;

FIG. 15 is a diagram illustrating a screen change in a basic operation of custom settings according to an embodiment;

FIG. 16 is a diagram illustrating a screen change in the case of performing a color change in custom settings according to an embodiment;

FIG. 17 is a diagram illustrating a screen change in the case of performing a density change in custom settings according to an embodiment;

FIG. 18 is a diagram illustrating a screen change in the case of performing a magnification change in custom settings according to an embodiment; and

FIG. 19 is a flowchart illustrating an operation of displaying a screen including a preview image according to an embodiment.

### DETAILED DESCRIPTION OF THE PREFERRED EMBODIMENTS

According to the conventional technique, however, a preview screen is viewed after switching (transitioning) from a function setting screen to the preview screen after setting up a function on the function setting screen, so that there is an operational problem in that this technique is not used unless a user is aware to some extent of the outcome of setting up the function. Further, in the case of setting up multiple functions, a user views a preview image after setting up each function, which complicates the user's operation.

That is, according to the conventional technique, there is a problem in that a user is forced to perform a complicated operation before display of a preview image after setting up functions.

According to an aspect of the present invention, an image processor and an image processing method are provided that make it possible to improve usability with respect to function settings and preview display, and a recording medium is provided on which a program is recorded that makes it possible to improve usability with respect to function settings and preview display.

According to an aspect of the present invention, it is possible to improve usability with respect to function settings and preview display.

A description is given, with reference to the accompanying drawings, of one or more embodiments of the present invention.

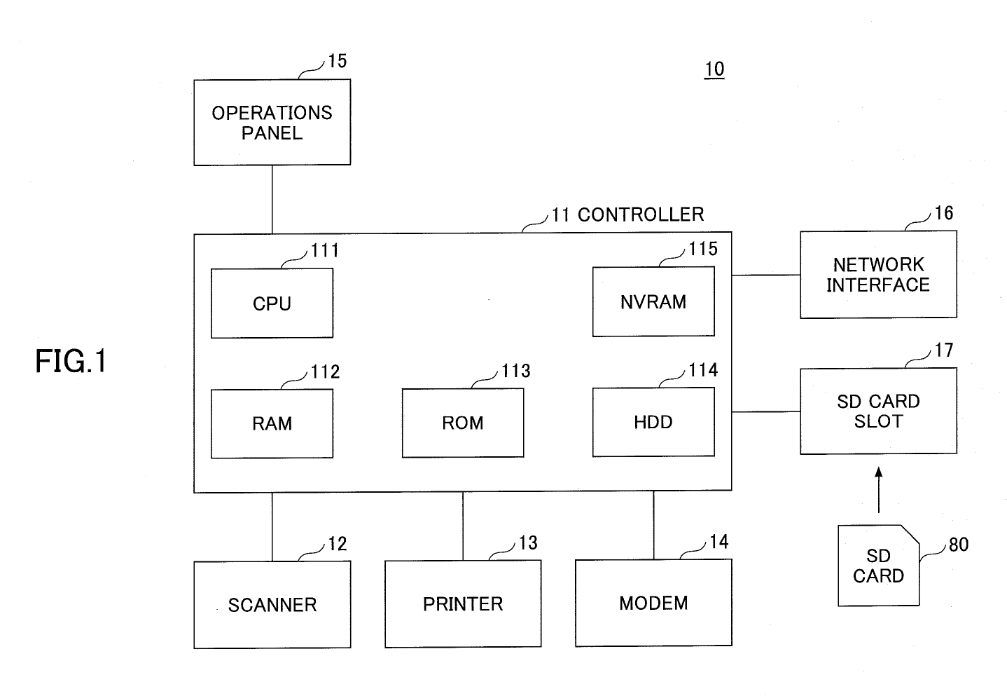

FIG. 1 is a block diagram illustrating hardware of an image processor according to an embodiment.

Referring to FIG. 1, an image processor 10 includes hardware items such as a controller 11, a scanner 12, a printer 13, a modem 14, an operations panel 15, a network interface 16, and an SD card slot 17. The image processor 10 may be, for example, a multifunction machine.

The controller 11 includes a central processing unit (CPU) 11, a random access memory (RAM) 112, a read-only memory (ROM) 113, a hard disk drive (HDD) 114, and a non-volatile RAM (NVRAM) 115.

The ROM 113 contains various programs and data used by programs. The RAM 112 is used as a storage area for loading programs and as a work area for the loaded programs.

The CPU 111 implements various functions by executing programs loaded into the RAM 112. The HDD 114 stores programs and various data used by programs. The NVRAM 115 stores various kinds of settings information.

The scanner 12 is a hardware item for reading image data from an original material such as a document. In the following, a description is given, taking a document as an example of the original material. The printer 13 is a hardware item for printing print data on printing paper. The modem 14 is a hardware item for connecting to a telephone line, and is used to perform transmission and reception of image data by facsimile (FAX) transmission.

The operations panel 15 is a hardware item that includes an input part and a display part such as a liquid crystal panel. The input part includes buttons for receiving a user's input. The network interface 16 is a hardware item for connecting to a network (either wired or wireless) such as a local area network (LAN).

The SD card slot 17 is used to read a program stored (recorded) in an SD card 80. That is, in the image processor 10, not only a program stored in the ROM 113 but also a program stored in the SD card 80 may be loaded into the RAM 112 and executed.

The SD card 80 may be replaced with other recording media (such as a CD-ROM and a universal serial bus (USB) memory). That is, recording media corresponding to the SD card 80 are not limited to predetermined kinds. In this case, the SD card slot 17 may be replaced with hardware corresponding to the kind of the recording medium.

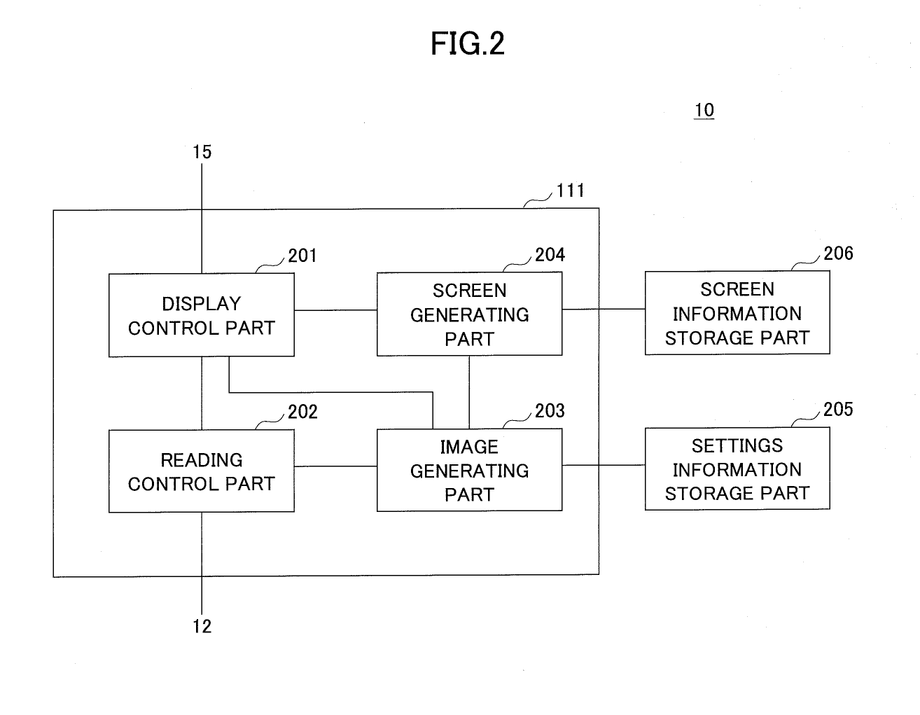

Next, a description is given of functions of the image processor 10. FIG. 2 is a block diagram illustrating functions of the image processor 10 according to an embodiment. The image processor 10 includes a display control part 201, a reading control part 202, an image generating part 203, a screen generating part 204, a settings information storage part 205, and a screen information storage part 206.

The display control part 201, the reading control part 202, the image generating part 203, and the screen generating part 204 may be implemented by, for example, the CPU 111 and the RAM 112 as a work memory. The settings information storage part 205 and the screen information storage part 206 may be implemented by, for example, the ROM 113 or the HDD 114. Further, the settings information storage part 205 and the screen information storage part 206 may be implemented by a single storage device.

The display control part 201 controls the display of operation screens of applications executed in the image processor 10. For example, the display control part 201 controls the display of a copy screen containing a preview image and UI components for calling preset copy functions. The UI components include icons and selectable buttons.

In response to detection of a start of document reading, the display control part 201 notifies the reading control part 202 of the start of document reading and notifies the image generating part 203 of information indicating UI components selected by a user.

As described below, the display control part 201 may render a preview image in accordance with dragging or flicking on the screen.

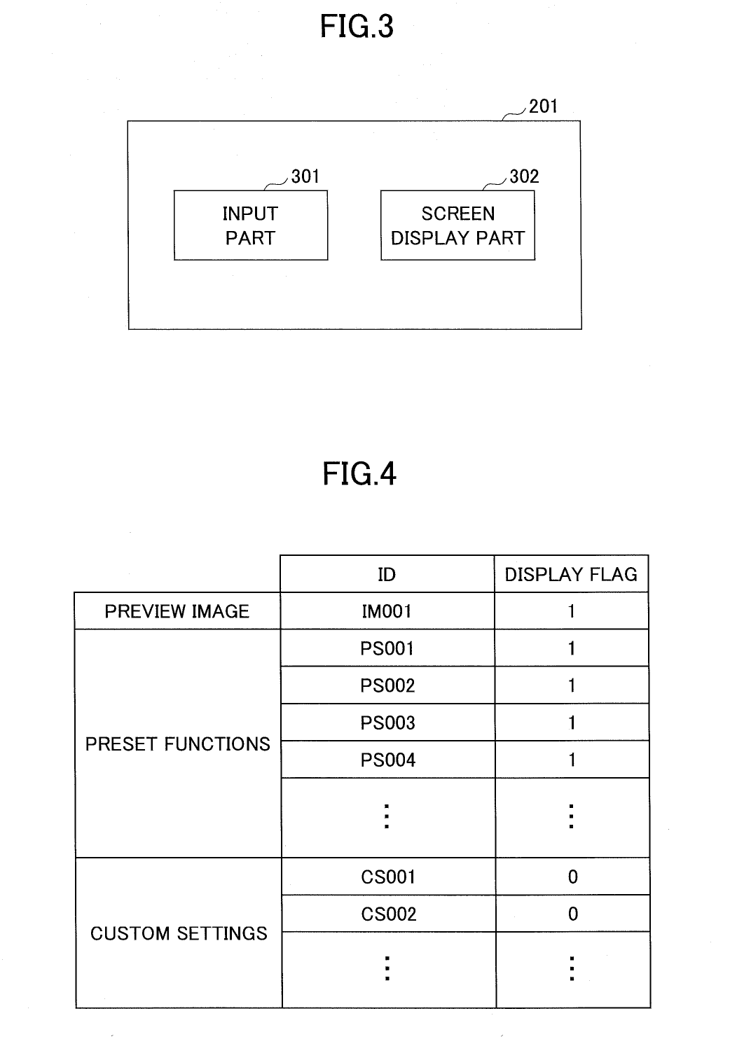

Thus, the display control part 201 has the function of displaying a screen and the function of inputting a user's operation on the displayed screen. FIG. 3 is a block diagram illustrating functions of the display control part 201.

Referring to FIG. 3, the display control part 201 includes an input part 301 and a screen display part 302. The input part 301 inputs a user's operation on the displayed screen, and outputs a request corresponding to the input to other parts.

For example, in response to detection of the pressing of a button for starting document reading, the input part 301 notifies the reading control part 202 of a start of document reading. In response to detection of a change of a selected UI component, the input part 301 notifies the image generating part 203 of information indicating a UI component after the change.

Further, when copy-related setting items are displayed on the copy screen, the input part 301 notifies the image generating part 203 of information indicating one or more setting items selected by a user. Further, in response to inputting a dragging or flicking operation on the screen, the input part 301 notifies the screen display part 302 of a request corresponding to the operation.

The screen display part 302 displays a screen generated by the screen generating part 204. For example, the screen display part 302 obtains the copy screen generated by the screen generating part 204, and displays the copy screen on the operations panel 15 (FIG. 1).

Further, the screen display part 302 allows page turning rendering of a preview image on the copy screen. This function is implemented in, for example, smartphones and electronic document display apparatuses.

Referring back to FIG. 2, the reading control part 202 controls the scanner 12 (FIG. 1) so as to control the reading of a document set at a predetermined position and generate an electronic image from this document. The reading control part 202 outputs the generated electronic image to the image generating part 203.

The image generating part 203 generates a preview image for a preset predetermined image or an electronic image obtained from the reading control part 202. The image generating part 203 generates a preview image using the predetermined image if a document has not been read (that is, before the reading of a document), or generates a preview image using the electronic image if a document has been read (that is, after the reading of a document). Any image may be used as the predetermined image as long as the image may be widely used.

The image generating part 203 generates a preview image using a function called by a UI component indicated by the UI component information transmitted from the display control part 201, that is, a UI component selected by a user to be located at a predetermined position. For example, when information indicating a UI component of duplex copying is obtained from the display control part 201, the image generating part 203 generates a duplex preview image.

The image generating part 203 obtains setting values corresponding to a UI component from the settings information storage part 205. Further, the image generating part 203 may also obtain the setting values of setting items for customization from the settings information storage part 205. The image generating part 203 generates a preview image based on setting values obtained from the settings information storage part 205. The image generating part 203 outputs the generated preview image to the screen generating part 204.

In generating a copy screen, the screen generating part 204 obtains the screen information of the copy screen from the screen information storage part 206, and generates the copy screen based on this screen information. The copy screen includes UI components for calling preset copy functions and the preview image generated by the image generating part 203. The screen generating part 204 outputs the generated copy screen to the display control part 201.

The settings information storage part 205 stores copy function information indicating preset copy functions and custom information containing the setting values of copy-related setting items. Each of the preset copy functions is one of or a combination of two or more of the setting values of copy-related setting items. A user may add preset copy functions.

The screen information storage part 206 stores the screen information of the copy screen. The screen information indicates the positioning of a preview image and the arrangement of UI components. The screen information also indicates the layout of the copy screen. If the UI components are icons, the screen information storage part 206 stores icon image information including respective icon images.

Next, a description is given of the data structures of information items used according to an embodiment. The screen information storage part 206 stores the screen information of the copy screen and icon image information.

FIG. 4 is a diagram illustrating an example of the screen information of the copy screen. In the screen information illustrated in FIG. 4, a preview image, preset functions, and custom settings correlated with respective IDs and display flags (display flag values). For example, the preview image is correlated with an ID “IM001,” the preset functions are correlated with IDs “PS001,” “PS002,” etc., and the custom settings are correlated with IDs “CS001,” “CS002,” etc. The value “1” of the display flag indicates display on the screen and the value “0” of the display flag indicates being outside the screen.

As described below, in the case of displaying UI components on a circumference, IDs corresponding to preset functions may be stored in, for example, an annular arrangement, and an ID at a home position (a predetermined position) may be identified so that a predetermined number of UI components on the right side and the left side of the ID at the home position may be displayed on the copy screen.

FIG. 5 is a diagram illustrating icon image information. In the icon image information illustrated in FIG. 5, icon images representing copy functions are correlated with respective icon IDs. The screen generating part 204 may obtain icon images corresponding to the IDs of objects of display from the icon image information illustrated in FIG. 5.

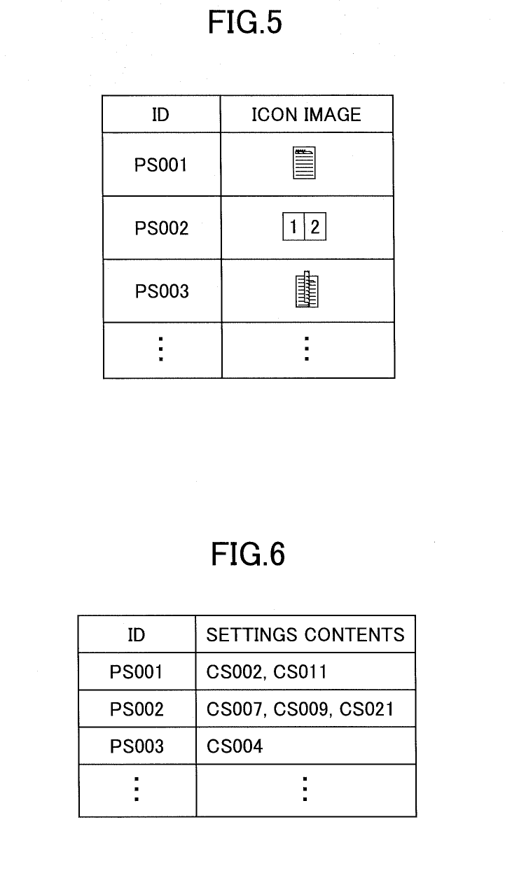

FIG. 6 is a diagram illustrating preset copy function information. In the copy function information illustrated in FIG. 6, copy functions have the contents of their settings correlated with respective IDs. The contents of the settings are a combination of custom IDs. For example, the copy function “PS001” is a combination of the custom IDs “CS002” and “CS011.”

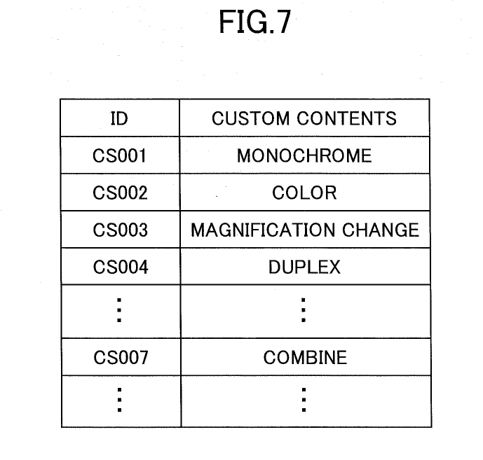

FIG. 7 is a diagram illustrating custom information. In the custom information illustrated in FIG. 7, custom contents are correlated with respective custom IDs. For example, the ID “CS001” represents “Monochrome,” the ID “CS002” represents “Color,” and the ID “CS003” represents “Reduce/Enlarge.”

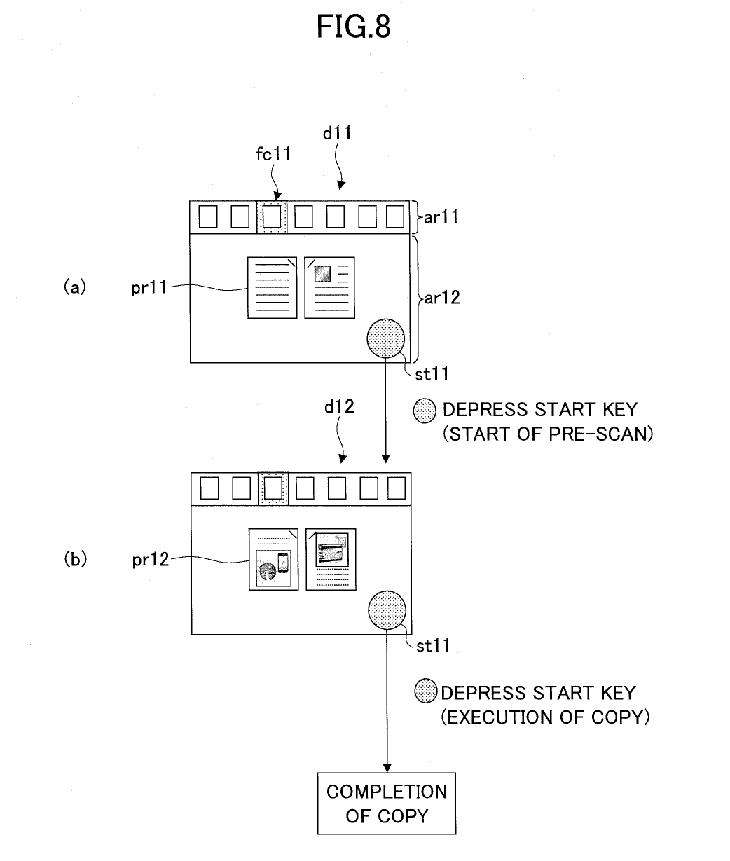

FIG. 8 is a diagram for giving an outline of a change of the copy screen. A screen d11 illustrated in (a) of FIG. 8 is a default screen (default state) of the copy screen. In an area ar11 of the default screen d11, the UI components of preset copy functions (for example, icons) are displayed. In an area ar12 of the default screen d11, a preview image pr11 is displayed.

The preview image pr11 of the default screen d11 is a preview image of a preset predetermined image. The preview image pr11 may be an enlarged image of an icon. The preview image pr11 is generated with setting values corresponding to a copy function fc11. The default screen d11 is generated by the screen generating part 204, and is displayed on the operations panel 15 by the display control part 201.

It is assumed that a user sets a document at a predetermined position and depresses a start key stll during display of the default screen d11. At this point, the display control part 201 notifies the reading control part 202 to start reading.

The reading control part 202 generates an electronic image by reading the document, and outputs the generated electronic image to the image generating part 203. The image generating part 203 generates a preview image from the electronic image. At this point, the preview image is generated using the setting values of the copy function fc11. The generated preview image is incorporated into the copy screen by the screen generating part 204. The display control part 201 displays the updated copy screen on the operations panel 15.

A screen d12 illustrated in (b) of FIG. 8 is the updated copy screen. A preview image pr12 is a preview image generated by reading the document. Thus, it is possible for a user to know the outcome of a copy function (what output is to be obtained by which copy function) in the state of the default screen d11. Further, it is possible for a user to see the preview image of an actual document by setting the document and performing a small number of operations (for example, a single operation). Thus, user operability is improved.

Next, a description is given, using a specific UI, of an example of the copy screen according to an embodiment. The following description of a screen is given of the case of selecting an icon while rotating icons representing copy functions arranged on a circumference rightward (counterclockwise) or leftward (clockwise). Further, a circle on which the icons are arranged is referred to as a table. A lower part of the table is displayed in an upper part of the screen. A preview image is displayed in a lower part of the screen.

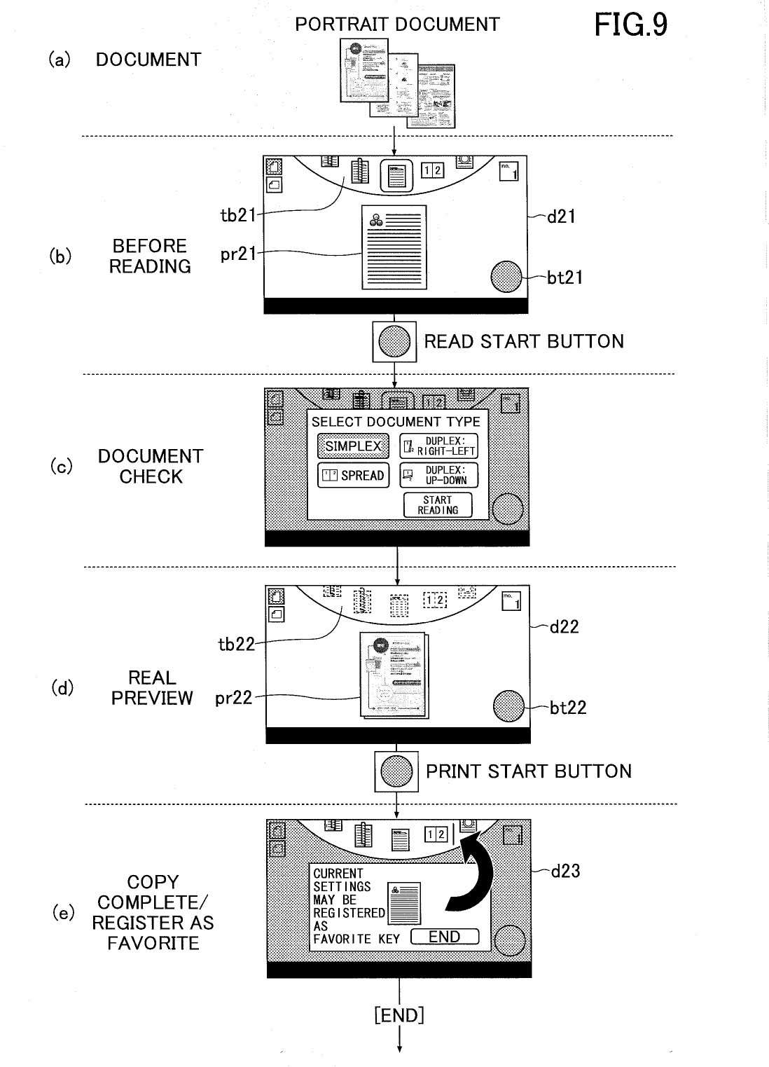

FIG. 9 is a diagram illustrating a copy screen related to basic operations from the copy screen. In the case illustrated in FIG. 9, a document of a portrait orientation (a portrait document) (as illustrated in (a)) is set. As illustrated in (b), in a screen d21 of this document before reading, a table tb21, a preview image pr21 of a predetermined image, and a Read Start button bt21 are displayed.

Next, when a user depresses the Read Start button bt21, the input part 301 of the display control part 201 (FIG. 3) detects the depression of the Read Start button bt21, and notifies the reading control part 202 (FIG. 2) to start reading. At this point, as illustrated in (c) of FIG. 9, the display control part 201 may display a document check screen before starting reading.

On the document check screen, the document type is selectable from Simplex, Duplex (right-left or up-down), and Spread. When a Read Start button (“Start Reading”) is depressed on this document check screen, the input part notifies the reading control part 202 to start reading.

The reading control part 202 generates an electronic image by reading the document. Next, the image generating part 203 generates a preview image of this electronic document. The screen generating part 204 generates a copy screen containing the generated preview image, and updates the copy screen.

As a result, as illustrated in (d) of FIG. 9, a copy screen d22 containing a preview image pr22 of the read image is displayed. The preview image pr22 is an actually read image displayed with the same layout as the preview image pr21 before reading. Further, the icons of a table tb22 may be in a half-bright highlight condition to be non-selectable.

Next, when a Print Start button bt22 of the copy screen d22 is depressed, the display control part 201 detects the depression of the Print Start button bt22, and controls the printer 13 so that the printer 13 executes copying. Further, a screen d23 illustrated in (e) of FIG. 9 illustrates the case of causing current settings to be registered (recorded) as a preset copy function.

As illustrated in the screen d23, when current settings are registered using an icon, the location of registration may be selected by turning (rotating) the table, and the icon may be drag-and-dropped to be registered at a specified position.

As illustrated in FIG. 9, preset copy functions and a preview image are displayed on a single screen, and when a document is read, the preview image is generated from the actually read image. Accordingly, it is possible for a user to know output for the preset copy function with the actual document, and basically, it is possible to perform selection of copy functions, display of a preview, and execution of printing on a single screen without transition of screens. Accordingly, user operability is improved.

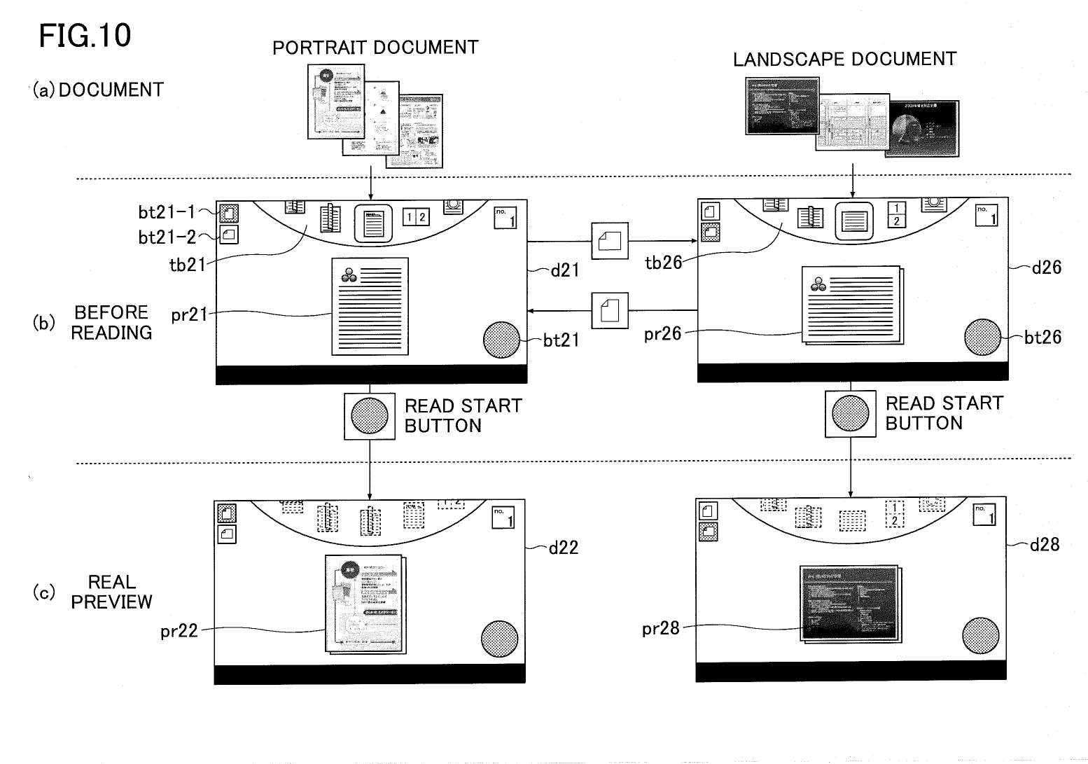

Next, a description is given of selecting a document orientation from a portrait orientation and a landscape orientation. FIG. 10 is a diagram illustrating a screen change between portrait settings and landscape settings.

In the case illustrated in FIG. 10, a screen d21 includes Portrait/Landscape settings switch buttons bt21-1 (from a portrait mode to a landscape mode) and bt21-2 (from a landscape mode to a portrait mode) as illustrated in (b). The display of the screen d21 and the display of a screen d26 may be switched by switching the selection of the button bt21-1 and the selection of the button bt21-2.

By switching paper settings to a landscape mode (for example, by selecting the button bt21-2), the table b21 and the preview image pr21 of the screen d21 are switched to a table bt26 and a preview image pr26, respectively, in a landscape mode on the screen d26. By switching paper settings to a portrait mode (for example, by selecting the button bt21-1), the screen d26 is switched to the screen d21.

When the Read Start button bt21 of the screen d21 is depressed, the screen d22 including the preview image pr22 of the portrait document ((a) of FIG. 10) is displayed as illustrated in (c) of FIG. 10. Further, when a Read Start button bt26 of the screen d26 is depressed, a screen d28 including a preview image pr28 of the landscape document ((a) of FIG. 10) is displayed as illustrated in (c) of FIG. 10.

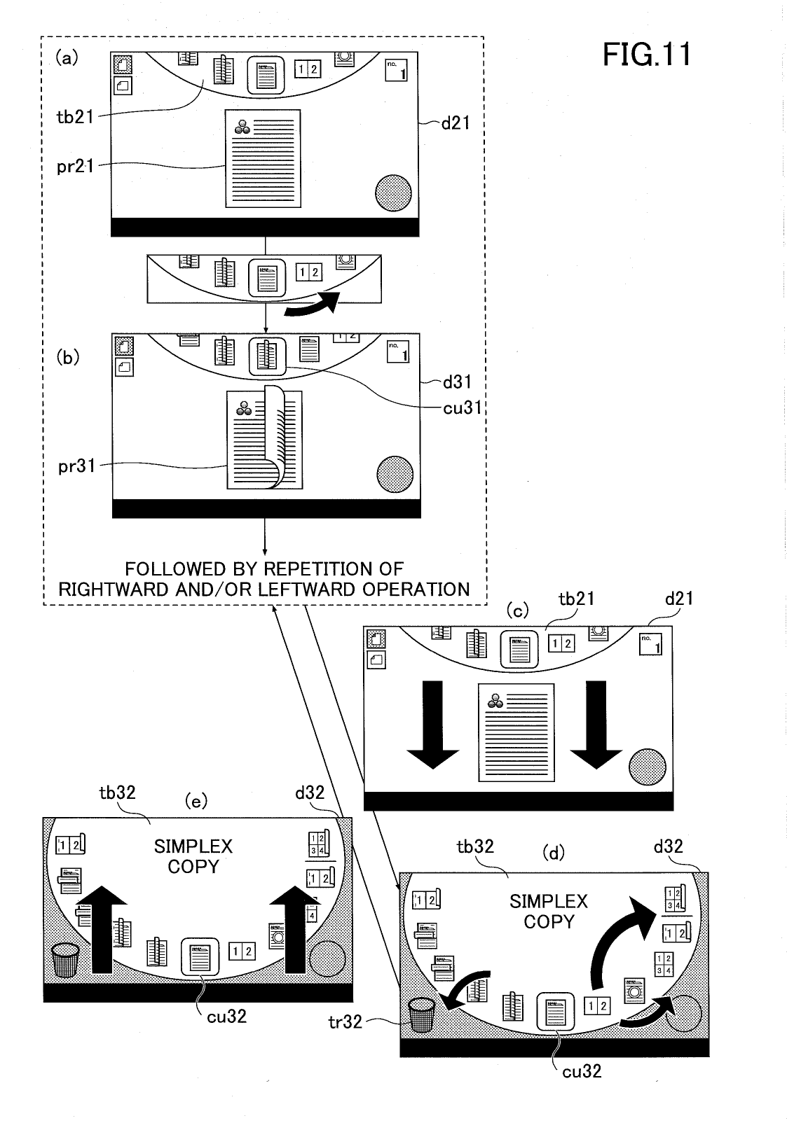

Next, a description is given of an operation of the table including the icons of copy functions. FIG. 11 is a diagram illustrating a screen change in a table operation.

In the case illustrated in FIG. 11, it is assumed that the table tb21 of the screen d21 illustrated in (a) is turned rightward (counterclockwise) by one icon slot (position). At this point, since a cursor cu31 is stationary, the icons move rightward by one slot each on a screen d31 as illustrated in (b). A preview image pr31 changes according to an icon in the cursor cu31. The position of the cursor cu31 corresponds to a home position (a predetermined position).

For example, if the icon inside the cursor cu31 is an icon of copy functions indicating “Duplex: Right-Left Spread”, the preview image pr31 is a preview image indicating “Duplex: Right-Left Spread” relative to a predetermined image.

For example, the display control part 201 detects a change of the icon inside the cursor cu31, and notifies the image generating part 203 of information on the icon inside the cursor cu31. The image generating part 203 obtains the setting values of copy functions by referring to the settings information storage part 205 based on the icon information transmitted from the display control part 201.

The image generating part 203 generates a preview image with the obtained setting values relative to a preset predetermined image. Further, the image generating part 203 may use an enlarged image of the icon inside the cursor cu31 as a preview image.

As another table operation, by dragging or flicking the table tb21 of the screen d21 illustrated in (c) of FIG. 11 downward, a screen d32 having a table tb32 enlarged in display area is displayed as illustrated in (d) of FIG. 11. The display d32 includes the table tb32 of a larger display area and a trash can icon (also simply referred to as “trash can”) tr32. As another table operation, by dragging or flicking the table tb32 of the screen d32 illustrated in (e) of FIG. 11 upward, the display is returned to the screen d21 having the table tb21 as illustrated in (c) of FIG. 11.

In the center of the table tb32, the name of the icon inside a cursor cu32 is displayed. The names of icons are automatically determined by the image processor 10. The table tb32 may be turned rightward (counterclockwise) and leftward (clockwise). The cursor position is fixed relative to the table tb32. Therefore, every time the table tb32 is turned, the icon name changes.

The trash can tr32 has the function of removing or deleting an icon from the table tb32 in response to the icon being drag-and-dropped into the trash can tr32 from inside the table tb32. Further, the order (of arrangement) of icons inside the table tb32 may be changed. The above-described table operations may be performed by the display control part 201 detecting a user's operation and changing the rendering of a screen in accordance with the detected operation.

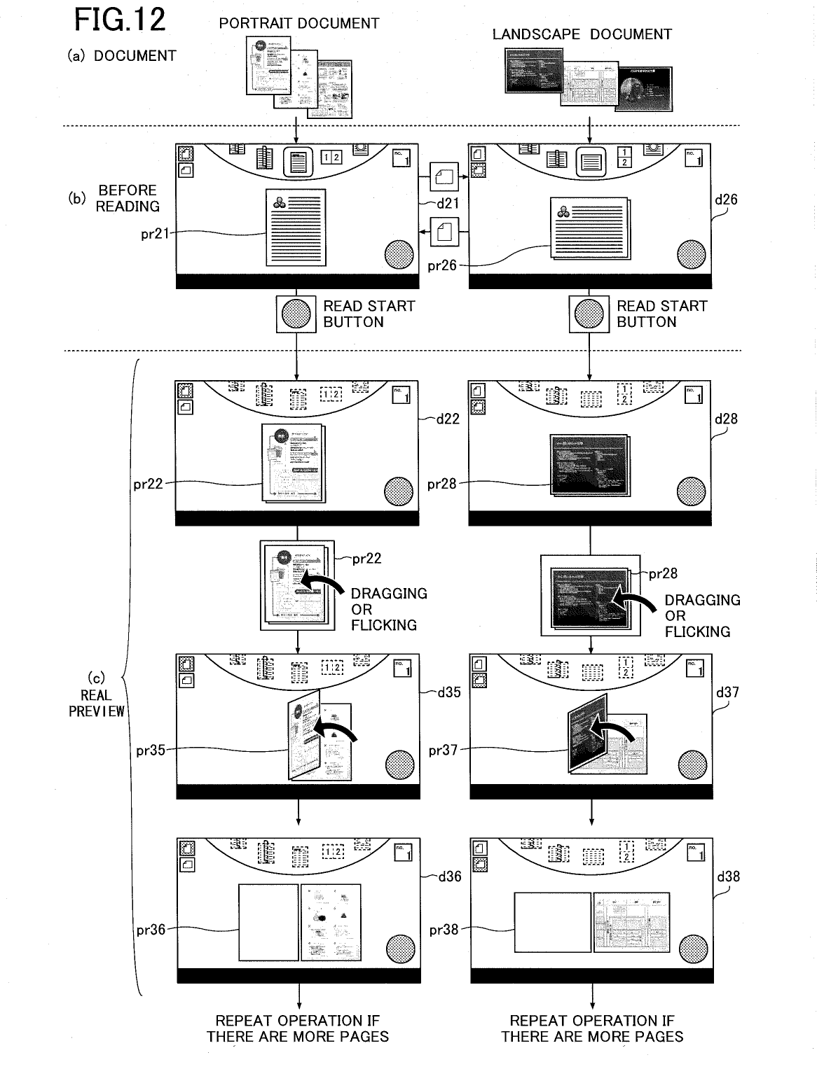

Next, a description is given of one-side page checking of a preview image. FIG. 12 is a diagram illustrating a screen change in a preview image page checking operation. The screens d21, d22, d26, and d28 illustrated in (b) and (c) of FIG. 12 are the same as those illustrated in FIG. 10.

When a user performs leftward dragging or flicking (flipping) on the preview image pr22 of the screen d22 illustrated in the top tier of (c) of FIG. 12, the first page is turned leftward, so that the back side of the first page (leaf) and the front side of the second page (leaf) are displayed as a preview image. This may be implemented by the animation function of the display control part 201.

A screen d35 illustrated in the middle tier of (c) of FIG. 12 includes a preview image pr35 in the middle of turning the first page (leaf). A screen d36 illustrated in the bottom tier of (c) of FIG. 12 includes a preview image pr36 that displays the back side of the first page (leaf) and the front side of the second page (leaf).

The same processing as performed on the portrait image is performed on the landscape image. That is, a screen d37 illustrated in the middle tier of (c) of FIG. 12 includes a preview image pr37 in the middle of turning the first page, and a screen d38 illustrated in the bottom tier of (c) of FIG. 12 includes a preview image pr38 that displays the back side of the first page and the front side of the second page. In the case illustrated in FIG. 12, the preview image is one-sided. Therefore, the back side of the first page (leaf) is blank. The first page of the document is displayed on the front side of the first page (leaf) of the preview image, and the second page of the document is displayed on the front side of the second page (leaf) of the preview image.

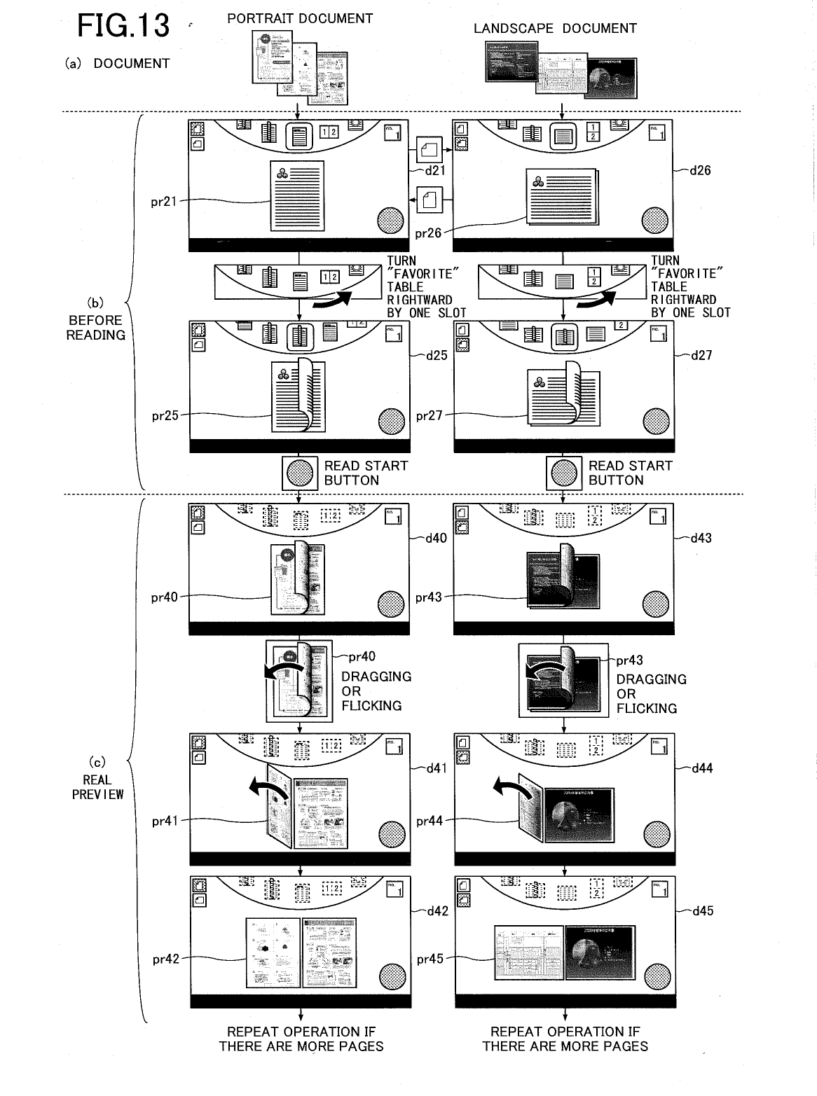

Next, a description is given of duplex right-left (lateral) spread page checking of a preview image. FIG. 13 is a diagram illustrating a screen change in another preview image page checking operation. The screen d21 and d26 illustrated in the top tier of (b) of FIG. 13 are the same as those illustrated in FIG. 10. A screen d25 illustrated in the bottom tier of (b) of FIG. 13 includes a preview image pr25 in the case of a duplex right-left spread portrait image. A screen d27 illustrated in the bottom tier of (b) of FIG. 13 includes a preview image pr27 in the case of a duplex right-left spread landscape image.

In the case illustrated in FIG. 13, when a user depresses a Read Start button of the screen d25, a preview image pr40 in the case of a duplex right-left spread landscape image is displayed on a screen d40 as illustrated in the top tier of (c) of FIG. 13. Even in a stationary state, the preview image pr40 makes it possible to understand that the preview image pr40 is a duplex right-left spread.

When a user performs leftward dragging or flicking (flipping) on the preview image pr40 of the screen d40 illustrated in the top tier of (c) of FIG. 13, the first page is turned leftward, so that the back side of the first page (leaf) and the front side of the second page (leaf) are displayed as a preview image. This may be implemented by the animation function of the display control part 201.

A screen d41 illustrated in the middle tier of (c) of FIG. 13 includes a preview image pr41 in the middle of turning the first page (leaf). A screen d42 illustrated in the bottom tier of (c) of FIG. 13 includes a preview image pr42 that displays the back side of the first page (leaf) and the front side of the second page (leaf). Since the preview image pr42 is a preview image of duplex printing, the second page of the document is displayed on the back side of the first page (leaf) of the preview image pr42, and the third page of the document is displayed on the front side of the second page (leaf) of the preview image pr42.

In the case illustrated in FIG. 13, when a user depresses a Read Start button of the screen d27, a preview image pr43 in the case of a duplex right-left spread landscape image is displayed on a screen d43 as illustrated in the top tier of (c) of FIG. 13. Even in a stationary state, the preview image pr43 makes it possible to understand that the preview image pr43 is a duplex right-left spread.

When a user performs leftward dragging or flicking (flipping) on the preview image pr43 of the screen d43 illustrated in the top tier of (c) of FIG. 13, the first page is turned leftward, so that the back side of the first page (leaf) and the front side of the second page (leaf) are displayed as a preview image. This may be implemented by the animation function of the display control part 201.

A screen d44 illustrated in the middle tier of (c) of FIG. 13 includes a preview image pr44 in the middle of turning the first page (leaf). A screen d45 illustrated in the bottom tier of (c) of FIG. 13 includes a preview image pr45 that displays the back side of the first page (leaf) and the front side of the second page (leaf). Since the preview image pr45 is a preview image of duplex printing, the second page of the document is displayed on the back side of the first page (leaf) of the preview image pr45, and the third page of the document is displayed on the front side of the second page (leaf) of the preview image pr45.

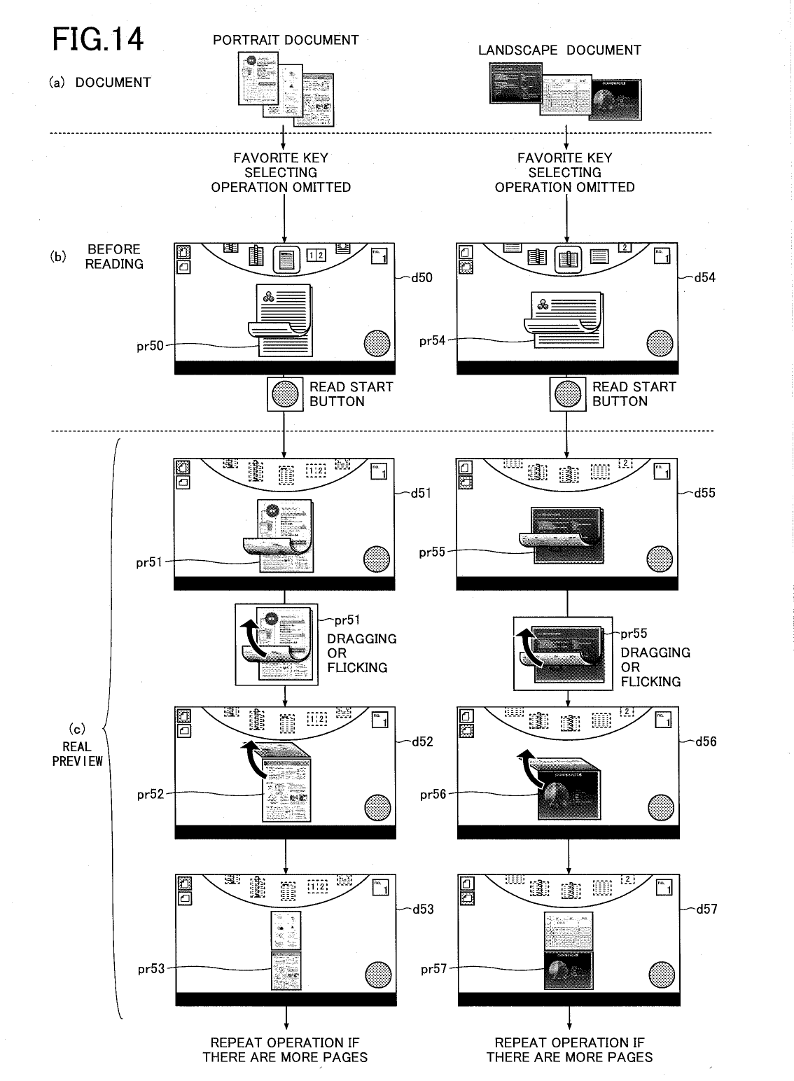

Next, a description is given of duplex up-down (vertical) spread page checking of a preview image. FIG. 14 is a diagram illustrating a screen change in yet another preview image page checking operation. A screen d50 illustrated in (b) of FIG. 14 is a screen including a duplex up-down spread preview image pr50 relative to a preset predetermined image of a portrait orientation (on the left side in (a) of FIG. 14).

In the case illustrated in FIG. 14, when a user depresses a Read Start button of the screen d50, a preview image pr51 in the case of a duplex up-down spread landscape image is displayed on a screen d51 as illustrated in the top tier of (c) of FIG. 14. Even in a stationary state, the preview image pr51 makes it possible to understand that the preview image pr51 is a duplex up-down spread.

When a user performs upward dragging or flicking (flipping) on the preview image pr51 of the screen d51 illustrated in the top tier of (c) of FIG. 14, the first page is turned upward, so that the back side of the first page (leaf) and the front side of the second page (leaf) are displayed as a preview image. This may be implemented by the animation function of the display control part 201.

A screen d52 illustrated in the middle tier of (c) of FIG. 14 includes a preview image pr52 in the middle of turning the first page (leaf). A screen d53 illustrated in the bottom tier of (c) of FIG. 14 includes a preview image pr53 that displays the back side of the first page (leaf) and the front side of the second page (leaf). Since the preview image pr53 is a preview image of duplex printing, the second page of the document is displayed on the back side of the first page (leaf) of the preview image pr53, and the third page of the document is displayed on the front side of the second page (leaf) of the preview image pr53.

A screen d54 illustrated in (b) of FIG. 14 is a screen including a duplex up-down spread preview image pr54 relative to a preset predetermined image of a landscape orientation (on the right side in (a) of FIG. 14).

In the case illustrated in FIG. 14, when a user depresses a Read Start button of the screen d54, a preview image pr55 in the case of a duplex up-down spread landscape image is displayed on a screen d55 as illustrated in the top tier of (c) of FIG. 14. Even in a stationary state, the preview image pr55 makes it possible to understand that the preview image pr55 is a duplex up-down spread.

When a user performs upward dragging or flicking (flipping) on the preview image pr55 of the screen d55 illustrated in the top tier of (c) of FIG. 14, the first page is turned upward, so that the back side of the first page (leaf) and the front side of the second page (leaf) are displayed as a preview image. This may be implemented by the animation function of the display control part 201.

A screen d56 illustrated in the middle tier of (c) of FIG. 14 includes a preview image pr56 in the middle of turning the first page (leaf). A screen d57 illustrated in the bottom tier of (c) of FIG. 14 includes a preview image pr57 that displays the back side of the first page (leaf) and the front side of the second page (leaf). Since the preview image pr57 is a preview image of duplex printing, the second page of the document is displayed on the back side of the first page (leaf) of the preview image pr57, and the third page of the document is displayed on the front side of the second page (leaf) of the preview image pr57.

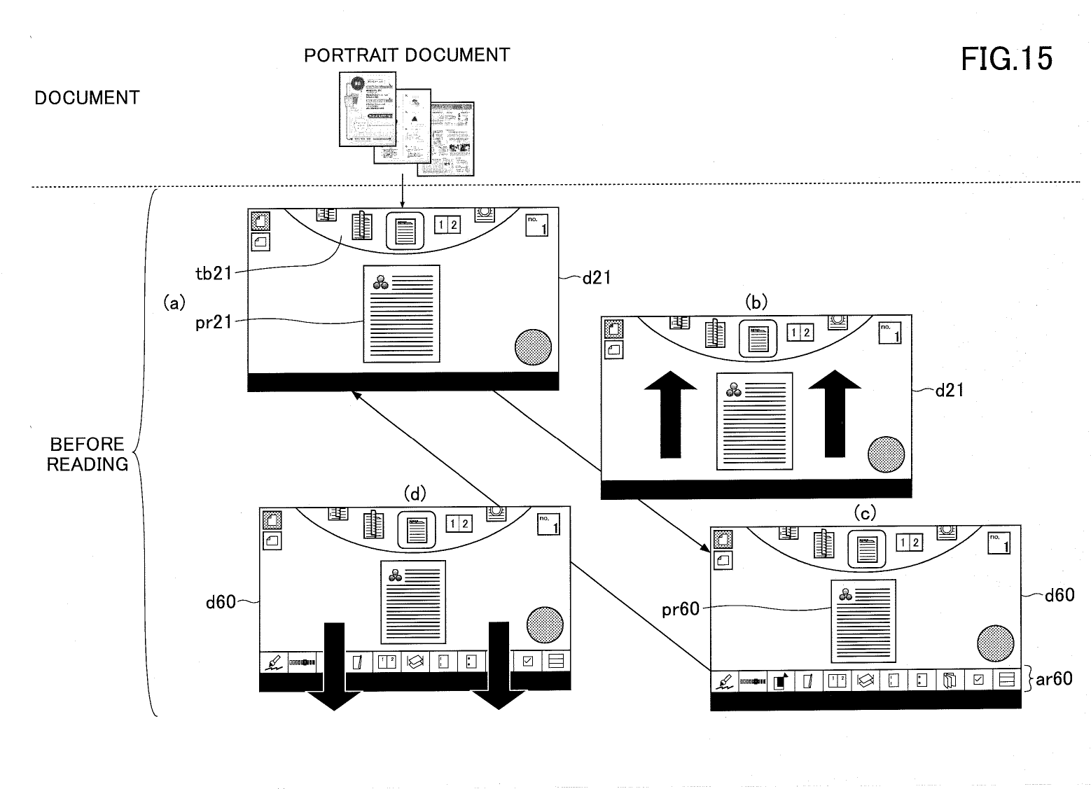

Next, a description is given of custom settings. FIG. 15 is a diagram illustrating a screen change in a basic operation of custom settings. In the case illustrated in FIG. 15, the icons of custom settings (custom icons) are displayed at the bottom of the screen by a user performing upward dragging or flicking on a lower part of the screen d21 of (a) of FIG. 15 as illustrated in (b) of FIG. 15.

A screen d60 illustrated in (c) of FIG. 15 is a screen including an area ar60 for displaying custom icons in its lower part (for example, at its bottom). A preview image pr60 inside the screen d60 is reduced (in size) compared with the normal preview image pr21 because of the display of the custom icon display area ar60.

By a user performing downward dragging or flicking on a lower part of the screen d60 including the area ar60 as illustrated in (d) of FIG. 15, the display returns to the screen d21 as illustrated in (a) of FIG. 15.

For example, when the display control part 201 detects an operation to display custom icons, the display control part 201 notifies the screen generating part 204 of the detection. In response to receiving the custom icon display request, the screen generating part 204 obtains the IDs of custom settings from the screen information stored in the screen information storage part 206, and includes icons corresponding to the IDs in a lower part of the screen. The display control part 201 displays and controls the screen updated by the screen generating part 204 (for example, the screen d60).

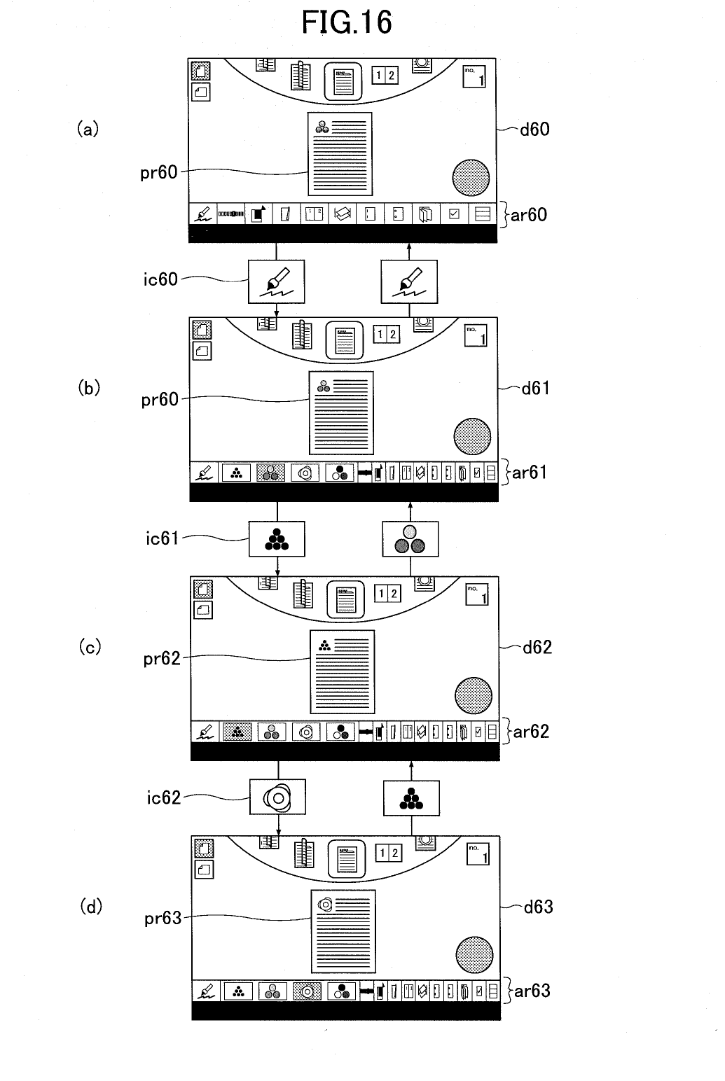

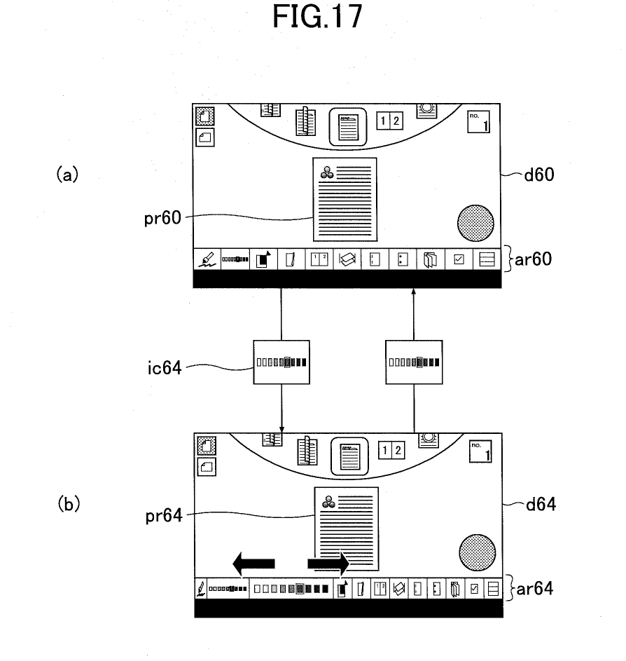

Next, a description is given of a color change in custom settings. FIG. 16 is a diagram illustrating a screen change in the case of performing a color change in custom settings. In the case illustrated in FIG. 16, it is assumed that a color setting icon ic60 of custom settings inside the screen d60 illustrated in (a) is selected.

At this point, as illustrated in (b) of FIG. 16, icons other than those related to color are reduced (in size) and caused to slide rightward or leftward and icons for color selection are displayed in an area ar61 on a screen d61. Here, in response to depression of an icon ic61, the screen d61 changes (switches) to a screen d62 on which a preview image pr62 of a color corresponding to the icon ic61 is displayed as illustrated in (c) of FIG. 16.

Further, when an icon ic62 in an area ar62 is depressed in the state of the screen d62, the screen d62 changes (switches) to a screen d63 on which a preview image pr63 of a color corresponding to the icon ic62 is displayed as illustrated in (d) of FIG. 16. This may be implemented by the display control part 201 receiving a user's operation and the image generating part 203 changing (updating) a preview image with a custom setting corresponding to the operated icon. The display control part 201 may recognize a custom setting operated by a user and change the RGB values of a preview image.

As a result, every time a user selects a color setting icon, the color of a preview image changes in response to the selected icon. This allows a user to easily understand the contents of the color setting icon.

Next, a description is given of a density change in custom settings. FIG. 17 is a diagram illustrating a screen change in the case of performing a density change in custom settings. In the case illustrated in FIG. 17, it is assumed that a density setting icon ic64 of custom settings inside the screen d60 illustrated in (a) is selected.

At this point, density notches are displayed in a custom settings area ar64 inside a screen d64 as illustrated in (b) of FIG. 17. A desired density may be set by performing tapping or dragging on these density notches. A preview image pr64 is displayed with the set desired density. The density may be changed by adjusting RGB values or a luminance value.

This allows a user to change density while viewing the preview image pr64. Therefore, it is possible for a user to understand output due to a density change.

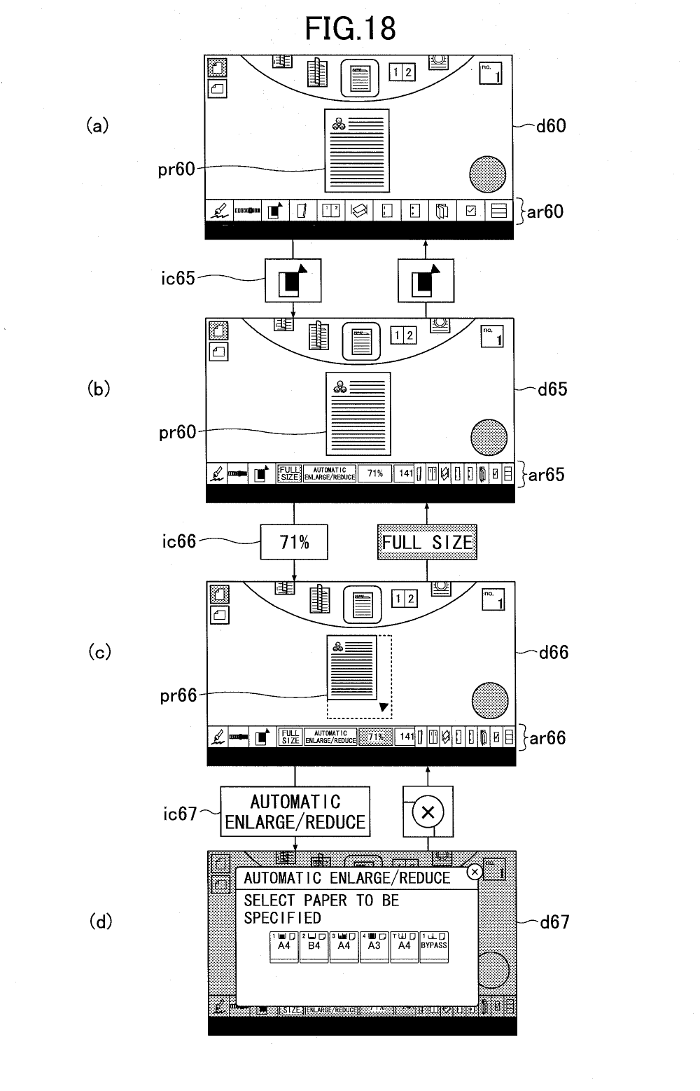

Next, a description is given of a magnification change in custom settings. FIG. 18 is a diagram illustrating a screen change in the case of performing a magnification change in custom settings. In the case illustrated in FIG. 18, it is assumed that a magnification change icon ic65 inside the screen d60 illustrated in (a) is selected.

At this point, as illustrated in (b) of FIG. 18, icons for changing magnification, such as an icon ic66, are displayed in a custom setting area ar65 on a screen d65. By setting (determining) magnification using the icon ic66, the magnification of the preview image pr60 is changed. In the case illustrated in FIG. 18, the magnification is changed from 100% to 71%. Therefore, as illustrated in (c) of FIG. 18, the preview image pr60 is reduced to a preview image pr66, which is 71% of the size of the preview image pr60, on a screen d66.

Further, when an automatic magnification change icon ic67 is selected in the state of the screen d66, a pop-up wizard of automatic magnification change is displayed on a screen d67 as illustrated in (d) of FIG. 18.

This allows a user to perform an automatic magnification change while viewing a preview image. Therefore, it is possible for a user to easily understand the effect of an automatic magnification change.

When a custom setting icon is selected, the display control part outputs information indicating the selected icon to the image generating part 203. In response to obtaining the information indicating the icon, the image generating part 203 obtains a setting value corresponding to the icon from, for example, the settings information storage part 205. The image generating part 203 generates a preview image using the obtained setting value, and outputs the generated preview image to the screen generating part 204.

Regarding custom settings of color, magnification change, density, etc., the display control part 201 may change the preview image.

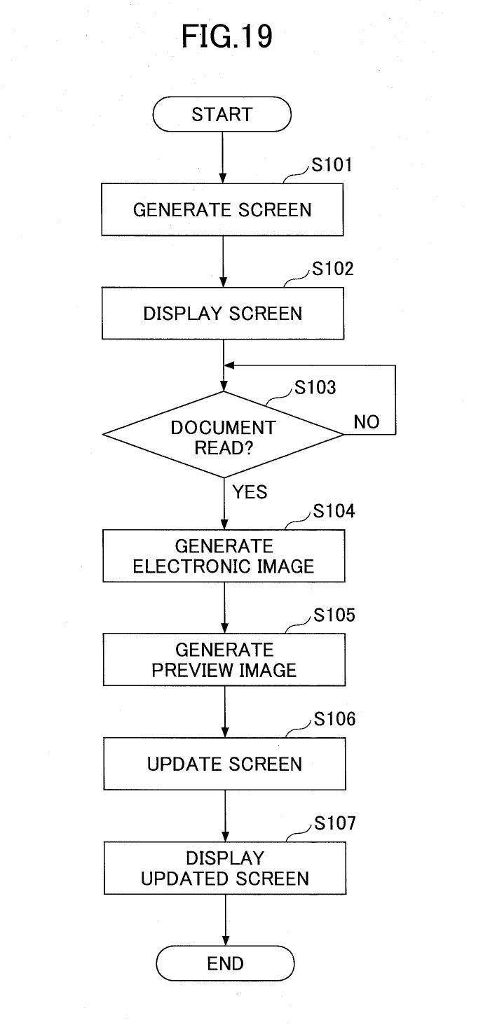

Next, a description is given of an operation of the image processor 10. FIG. 19 is a flowchart illustrating an operation of displaying a screen including a preview image according to an embodiment. In step S101 of FIG. 19, the screen generating part 204 generates a default screen (such as the screen d21 illustrated in (b) of FIG. 9) based on screen information indicating a screen icon layout.

In step S102, the display control part 201 (the screen display part 302) displays the screen generated by the screen generating part 204 on the operations panel 15.

In step S103, the display control part 201 (the input part 301) determines whether a Read Start button has been depressed. If the display control part 201 detects depression of the Read Start button (YES in step S103), the process proceeds to step S104. If the display control part 201 does not detect depression of the Read Start button (NO in step S103), the process returns to step S103.

In step S104, in response to an instruction to read a document, the reading control part 202 reads the document and generates an electronic image of the document.

In step S105, the image generating part 203 obtains the electronic document from the reading control part 202, and generates a preview image using the setting values of the copy functions of an icon at a predetermined position.

In step S106, the screen generating part 204 updates the screen by incorporating the preview image generated by the image generating part 203 into the screen.

In step S107, the display control part 201 obtains the screen updated by the screen generating part 204 and displays the obtained screen on the operations panel 15.

Thus, according to the above-described embodiments, a user's operation for displaying a preview image is unnecessary, and a screen transition from a copy screen to a preview screen is unnecessary. Accordingly, user operability is improved with respect to function settings and preview display.

A program executed in the image processor 10 according to the embodiments may be provided by being recorded as a file of an installable or executable format on a computer-readable recording medium such as an SD card (for example, the SD card 80 of FIG. 1), a CD-ROM, a flexible disk (FD), a CD-R, or a DVD (digital versatile disk).

Further, a program executed in the image processor 10 according to the embodiments may be provided by being stored in a computer connected to a network such as the Internet and downloaded via the network. Further, a program executed in the image processor 10 according to the embodiments may be provided or distributed via a network such as the Internet.

Further, a program executed in the image processor 10 according to the embodiments may be provided by being incorporated into a ROM (for example, the ROM 113 of FIG. 1) or the like in advance.

A program executed in the image processor 10 according to the embodiments has a modular configuration including the above-described parts. As an actual hardware operation, the CPU 111 (FIG. 1) reads the program from, for example, the HDD 114 (FIG. 1) and executes the program, so that one or more of the above-described parts are loaded into and generated in the RAM 112 (FIG. 1).

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. An image processor, comprising:
a display control part configured to display and control a screen that includes a plurality of UI components for calling preset copy functions, and a preview image;
a reading control part configured to control reading of an original material, and to generate an electronic image of the original material;
an image generating part configured to generate a preview image based on one or more of the copy functions called by one of the UI components at a predetermined position inside the screen, using a preset predetermined image before the original material is read or using the electronic image after the original material is read; and
a screen generating part configured to generate the screen using the preview image generated by the image generating part, and to output the generated screen to the display control part.

2. The image processor as claimed in claim 1, wherein when another one of the UI components replaces the one of the UI components at the predetermined position, the display control part notifies the image generating part of information indicating said another one of the UI components, and
the image generating part generates the preview image of the predetermined image or the electronic image based on one or more of the copy functions called by said another one of the UI components indicated by the information of which the image generating part has been notified.

3. The image processor as claimed in claim 1, wherein in a case where setting items of the copy functions are selectably displayed on the screen, when one or more of the setting items are selected, the display control part notifies the image generating part of information indicating the selected one or more of the setting items, and
the image generating part generates the preview image of the predetermined image or the electronic image using a setting value of the selected one or more of the setting items indicated by the information of which the image generating part has been notified.

4. The image processor as claimed in claim 1, wherein the reading control part controls the reading of the original material of a plurality of pages and generates the electronic image of the original material of the plurality of pages, and
when the one of the UI components at the predetermined position includes a duplex copy function, the image generating part generates the preview image from which it is understandable that the preview image is duplex.

5. The image processor as claimed in claim 4, wherein when the one of the UI components at the predetermined position includes the duplex copy function, the display control part controls rendering of turning a page of the preview image in a laterally spreading manner or in a vertically spreading manner in response to a dragging or flicking operation on the preview image.

6. A non-transitory computer-readable recording medium having a program recorded thereon for causing a computer to execute:
displaying and controlling a screen that includes a plurality of UI components for calling preset copy functions, and a preview image;
controlling reading of an original material, and generating an electronic image of the original material;
generating a preview image based on one or more of the copy functions called by one of the UI components at a predetermined position inside the screen, using the electronic image after the original material is read; and
generating the screen using the generated preview image.

7. The non-transitory computer-readable recording medium as claimed in claim 6, wherein when another one of the UI components replaces the one of the UI components at the predetermined position, said generating the preview image generates the preview image of the electronic image based on one or more of the copy functions called by said another one of the UI components based on information indicating said another one of the UI components.

8. The non-transitory computer-readable recording medium as claimed in claim 6, wherein in a case where setting items of the copy functions are selectably displayed on the screen, when one or more of the setting items are selected, said generating the preview image generates the preview image of the electronic image using a setting value of the selected one or more of the setting items based on information indicating the selected one or more of the setting items.

9. The non-transitory computer-readable recording medium as claimed in claim 6, wherein said controlling the reading of the original material and generating the electronic image controls the reading of the original material of a plurality of pages and generates the electronic image of the original material of the plurality of pages, and
when the one of the UI components at the predetermined position includes a duplex copy function, said generating the preview image generates the preview image from which it is understandable that the preview image is duplex.

10. The non-transitory computer-readable recording medium as claimed in claim 9, wherein when the one of the UI components at the predetermined position includes the duplex copy function, said displaying and controlling the screen controls rendering of turning a page of the preview image in a laterally spreading manner or in a vertically spreading manner in response to a dragging or flicking operation on the preview image.

11. An image processing method, comprising:
displaying and controlling a screen that includes a plurality of UI components for calling preset copy functions, and a preview image;
controlling reading of an original material, and generating an electronic image of the original material;
generating a preview image based on one or more of the copy functions called by one of the UI components at a predetermined position inside the screen, using the electronic image after the original material is read; and
generating the screen using the generated preview image.
